(19) United States
(12) Patent Application Publication
(10) Pub. No.: US 2024/0330079 A1
(43) Pub. Date: Oct. 3, 2024

(54) DATA COMMUNICATION METHOD AND ELECTRONIC DEVICE

(71) Applicant: HISENSE VISUAL TECHNOLOGY CO., LTD., Qingdao (CN)

(72) Inventor: Zhenhua PANG, Qingdao (CN)

(21) Appl. No.: 18/739,322

(22) Filed: Jun. 11, 2024

Related U.S. Application Data
(63) Continuation of application No. PCT/CN2023/143671, filed on Dec. 29, 2023.

(30) Foreign Application Priority Data
Mar. 21, 2023 (CN) 202310280055.1
May 15, 2023 (CN) 202310545206.1
May 15, 2023 (CN) 202310547465.8

(51) Int. Cl. G06F 9/54

(52) U.S. Cl. CPC G06F 9/54

(57) ABSTRACT

A data communication method and an electronic device are provided in the present application, where the method can include: for each drive group, acquiring drive data and channel quantities of a plurality of drive chips in the drive group; generating, based on the drive data and the channel quantities of the plurality of drive chips in the drive group, drive data of the drive group; where the drive data of the drive group can include a plurality of data segments corresponding one-to-one with the drive chips, and the drive data of the drive group can include data compensation information related to the channel quantities of the respective drive chips; and sending, to each drive group, corresponding drive data of the drive group, so that each drive chip in the drive group can acquire its corresponding drive data based on the data compensation information.

### CROSS-REFERENCE TO RELATED APPLICATION

This application is a continuation application of International Application No. PCT/CN2023/143671, filed on Dec. 29, 2023, which claims priority to: Chinese Patent Application No. 202310280055.1, filed on Mar. 21, 2023 to the China National Intellectual Property Administration; Chinese Patent Application No. 202310547465.8, filed on May 15, 2023 to the China National Intellectual Property Administration; and Chinese Patent Application No. 202310545206.1, filed on May 15, 2023 to the China National Intellectual Property Administration. All of the above applications are hereby incorporated by reference in their entireties.

### TECHNICAL FIELD

The present application relates to a data communication method and an electronic device.

### BACKGROUND

A display apparatus is an apparatus for displaying images and/or user interfaces. The display apparatus is usually equipped with at least one controller, a drive circuit, and a plurality of light strings for providing backlight. The drive circuit can include at least one drive chip, where respective drive chips include a same channel quantity and drive corresponding quantities of light strings to emit light. Currently, it has become a research hotspot to improve the channel utilization of the respective drive chips.

### SUMMARY

Embodiments of the present application provide a data communication method for an electronic device, where the electronic device comprises at least one controller, the at least one controller can be connected to at least one drive group, the drive group can include a plurality of drive chips sequentially connected in series, and at least one drive chip of the plurality of drive chips has a different channel quantity from remainder drive chips; the method can include:
for each drive group, acquiring drive data and channel quantities of the plurality of drive chips in the drive group;
generating, based on the drive data and the channel quantities, drive data of the drive group; where the drive data of the drive group can include a plurality of data segments corresponding one-to-one with the drive chips, and the drive data of the drive group can include data compensation information related to the channel quantities of the respective drive chips;
sending, to each drive group, corresponding drive data of the drive group, so that each drive chip in the drive group can acquire its corresponding drive data based on the data compensation information.

The embodiments of the present application further provide a data communication method for a drive chip, where the drive chip can be included in a drive group, the drive group can include a plurality of drive chips sequentially connected in series, and at least one drive chip of the plurality of drive chips has a different channel quantity from remainder drive chips, the drive group can be connected with at least one controller; the method can include:
receiving drive data of the drive group; where the drive data of the drive group can be generated by the at least one controller based on drive data and channel quantities of the plurality of drive chips, the drive data of the drive group can include a plurality of data segments corresponding one-to-one with the drive chips, and the drive data of the drive group can include data compensation information related to the channel quantities of the respective drive chips;
acquiring, based on the data compensation information, drive data corresponding to the drive chip from the drive data of the drive group.

The embodiments of the present application further provide an electronic device, including: at least one processor, and a memory in connection with the at least one processor; where the memory can be configured to store computer executable instructions;
the at least one processor can be configured to execute the computer executable instructions to cause the electronic device to perform the above data communication method.

The embodiments of the present application further provide a computer-readable non-volatile storage medium storing computer instructions thereon, where the computer instructions can be executed by a processor to enable a computer device execute any data communication method as mentioned above.

### BRIEF DESCRIPTION OF DRAWINGS

FIG. 1 is a schematic diagram of an operation scenario between a display apparatus and a control device according to some embodiments.

FIG. 2 is a block diagram of configurations of a control device according to some embodiments.

FIG. 3 is a schematic structure diagram of a display apparatus according to some embodiments.

FIG. 4 is an architecture diagram of a display according to some embodiments.

FIG. 5 is a schematic flowchart of a data communication method according to some embodiments.

FIG. 6 is a schematic flowchart of a data communication method according to some other embodiments.

FIG. 7 is a schematic structure diagram of a display apparatus according to some other embodiments.

FIG. 8 is a schematic flowchart of a data communication method according to some other embodiments.

FIG. 9 is a schematic structure diagram of drive data of a drive group according to some embodiments.

FIG. 10 is a schematic flowchart of a data communication method according to some other embodiments.

FIG. 11 is a schematic structure diagram of drive data of a drive group according to some embodiments.

FIG. 12 is a schematic flowchart of a drive chip reading drive data according to some other embodiments.

FIG. 13 is a schematic flowchart of a data communication method according to some other embodiments.

FIG. 14 is a schematic flowchart of a data communication method according to some other embodiments.

FIG. 15 is a schematic structure diagram of a data segment according to some embodiments.

FIG. 16 is a schematic flowchart of a data communication method according to some other embodiments.

FIG. 17 is a schematic flowchart of a data communication method according to some other embodiments.

FIG. 18 is a schematic structure diagram of an electronic device according to some embodiments.

### DESCRIPTION OF EMBODIMENTS

Here, a detailed explanation of exemplary embodiments will be provided, which are illustratively presented in the drawings. When the following description involves drawings, unless otherwise represented, the same number in different drawings represents the same or similar elements. The implementations described in the following exemplary embodiments do not represent all embodiments consistent with the present application. On the contrary, they are only examples of apparatuses and methods consistent with some aspects as detailed in the appended claims and some aspects of the present application.

It should be noted that the brief explanation of terms in the present application is only for the convenience of understanding the implementations described below, and is not intended to limit the implementations of the present application. Unless otherwise specified, these terms should be understood according to their common and usual meanings.

The terms “first”, “second”, etc., in the description, claims, and the above drawings of the present application are used to distinguish similar objects or entities, but not necessarily mean limiting a specific order or sequence, unless otherwise indicated (Unless otherwise indicated). It should be understood that, the terms used in this way is interchangeable where appropriate, and for example, can be implemented in an order other than what is illustrated or described in the embodiments of the present application.

In addition, the terms “include” and “have” and any variations of them are intended to cover non-exclusive inclusion. For example, products or devices containing a series of components are not necessarily limited to those components that are clearly listed, but can include other components that are not clearly listed or are inherent to these products or devices. The term “circuit” used in the present application refers to any known or later developed hardware, software, firmware, artificial intelligence, fuzzy logic, or a combination of hardware and/or software codes capable of performing functions related to the element.

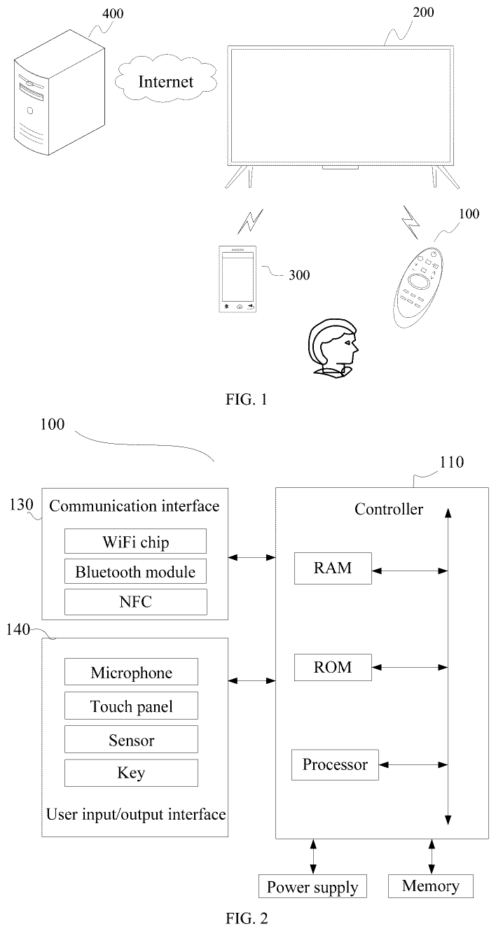

FIG. 1 is a schematic diagram showing an operation scenario between a display apparatus and a control device in some embodiments of the present application. As shown in FIG. 1, a user can operate a display apparatus 200 through an intelligent device 300 or a control device 100.

In some embodiments, the control device 100 may be a remote controller, and the communication between the remote controller and the display apparatus can include infrared protocol communication or Bluetooth protocol communication, as well as other short distance communication manner, to control the display apparatus 200 wirelessly or wiredly. Users can input user instructions through keys, voice input, or control panel input, etc. on the remote controller, to control the display apparatus 200.

In some embodiments, the intelligent device 300 (such as a mobile terminal, a tablet, a computer, a laptop, etc.) can also be used to control the display apparatus 200. For example, an application running on the intelligent device can be used to control the display apparatus 200.

In some embodiments, the display apparatus may receive user control through touch or gestures, instead of using the aforementioned intelligent device or control device to receive instructions.

In some embodiments, the display apparatus 200 may also be controlled using other means in addition to the control device 100 and the intelligent device 300. For example, it can be controlled by receiving the user's voice instructions directly through the module configured internally in the display apparatus 200 for acquiring the voice instructions, or it can also be controlled by receiving the user's voice instructions through a voice control device set externally to the display apparatus 200.

In some embodiments, the display apparatus 200 also can perform data communication with a server 400. It is possible to allow the display apparatus 200 to communicate and couple through a local area network (LAN), a wireless local area network (WLAN), and other networks. The server 400 can provide various contents and interactions to the display apparatus 200. The server 400 can be a cluster or a plurality of clusters, and can include one or more types of servers.

FIG. 2 is a block diagram showing configurations of the control device 100 in some embodiments of the present application. As shown in FIG. 2, the control device 100 can include a controller 110, a communication interface 130, a user input/output interface 140, a memory 160, and a power supply 150. The control device 100 can receive operation commands from a user, and convert the operation commands into instructions that the display apparatus 200 can recognize and respond to, playing a mediating role in the interaction between the user and the display apparatus 200.

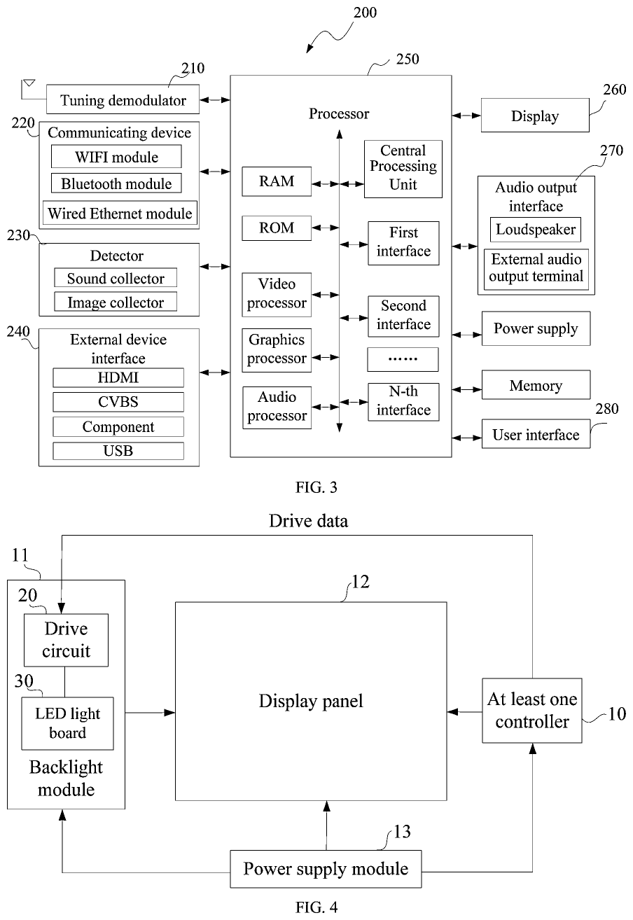

FIG. 3 is a schematic structure diagram of a display apparatus in some embodiments of the present application. As shown in FIG. 3, the display apparatus 200 can include at least one of a tuning demodulator 210, a communicating device 220, a detector 230, an external device interface 240, a processor 250, a display 260, an audio output interface 270, a memory 160, a power supply 150, and a user interface 280.

In some embodiments, the processor can include one or more processors, for example, a video processor, an audio processor, a graphics processor, a RAM, a ROM, and a first interface to an n-th interface for input/output.

The display 260 can include: a display screen component for presenting images, as well as a drive component for driving image display, a component used for receiving image signals output from the controller, displaying video content, image content and a menu control interface, and a user control UI interface.

The display 260 may be a liquid crystal display, an OLED (Organic Light-Emitting Diode) display, and a projection display, as well as a projection apparatus and a projection screen.

The communicating device 220 can be a component configured to communicate with external devices or servers according to various communication protocols. For example, the communicating device may include at least one of a Wifi module, a Bluetooth module, a wired Ethernet module, and other network communication protocol chip or near-field communication protocol chip, and an infrared receiver. The display apparatus 200 can establish the transmission and reception of control signals and data signals with the external control device 100 or the server 400 through the communicating device 220.

The user interface 280 can be configured to receive control signals from the control device 100 (such as an infrared remote controller, etc.).

The detector 230 can be configured to collect signals from external environments or signals for interaction with the outside. For example, the detector 230 can include an optical receiver, a sensor for collecting ambient light intensity; alternatively, the detector 230 may include an image collector, such as a camera, which can be used to capture external environmental scenes, user attributes, or user interaction gestures; further alternatively, the detector 230 may include a sound collector, such as a microphone, configured to receive external sound.

The external device interface 240 may include, but is not limited to, any one or more interfaces such as a high definition multimedia interface (HDMI), an analog or data high definition component input interface (component), a composite video input interface (CVBS), a USB input interface (USB), an RGB port, etc. It can also be a composite input/output interface formed by the above interfaces.

The tuning demodulator 210 can receive broadcast television signals through a wired or wireless reception manner, and demodulate audio and video signals, such as EPG data signals, from a plurality of wireless or wired broadcast television signals.

In some embodiments, the processor(s) 250 and the tuning demodulator 210 may be located in different individual devices, i.e. the tuning demodulator 210 may also be located in an external device of the main device where the processor(s) 250 is located, such as an external set top box, etc.

The processor(s) 250 can control the operation of the display apparatus and respond to user operations through various software control programs stored in the memory 160. The processor(s) 250 can control the overall operation of display apparatus 200. For example, in response to receiving a user command for selecting a UI object to be displayed on the display 260, the processor(s) 250 can perform an operation related to an object selected by the user command.

In some embodiments, the processor(s) can include at least one of a central processing unit (CPU), a video processor, an audio processor, a graphics processing unit (GPU), a random access memory (RAM), a backlight controller (abbreviated as Bcon), a ROM (ROM), a first interface to an n-th interface for input/output, a communication bus (Bus), etc.

A user can input a user command through a graphic user interface (GUI) displayed on the display 260, and the user input interface can receive the input user command through the graphic user interface (GUI). Alternatively, the user can input the user command by inputting a specific sound or gesture, and the user input interface can recognize the sound or gesture through a sensor to receive the input user command.

The “user interface” may be a medium interface for interaction and information exchange between an application or an operating system and a user, which realizes the conversion between the internal form of information and the user-acceptable form of information. A common representation of the user interface is the graphic user interface (Graphic User Interface, GUI), which refers to a user interface related to computer operations displayed in a graphical manner. It can be an icon, a window, a control and other interface elements displayed on the display screen of an electronic device, where the control can include a visual interface element such as an icon, a button, a menu, a tab, a text box, a dialog box, a status bar, a navigation bar, a Widget, etc.

FIG. 4 is a schematic diagram showing an architecture of a display in some embodiments of the present application. As shown in FIG. 4, the display can include a display panel 12, at least one controller 10 and a backlight module 11, and a power supply module 13.

The power supply module 13 can be connected to the at least one controller 10, the display panel 12 and the backlight module 11, and can be configured to supply power to the at least one controller 10, the display panel 12 and the backlight module 11.

The at least one controller 10, as a main control of the display, can be configured to: receive signals from a computer or other video sources; determine and perform format conversion, timing control and other processing on backlight data and display data; and send the processed backlight data to a backlight component, as well as send the processed display data to the display panel. The at least one controller 10 may include a system on chip (abbreviated as SOC), a timing controller (abbreviated as Tcon), and a backlight controller (abbreviated as Bcon). In some embodiments, the Bcon may be replaced with a dimming controller (abbreviated as Dcon).

The display panel 12 can be connected to the at least one controller 10, and in some embodiments, the display panel 12 may be connected to the Tcon. The display panel 12 can include liquid crystal molecules, the liquid crystal molecules can be configured to deflect based on the processed display data received by the display panel and display an image based on the backlight provided by the backlight module.

The backlight module 11 can be connected to the at least one controller 10, and in some embodiments, the backlight module 11 may be connected to the Bcon or Dcon. The backlight module 11 can be configured to generate corresponding backlight based on the processed backlight data received by the backlight module.

The backlight module 11, from top to bottom, can include: a film, a diffusion plate, a bracket, a reflector, a light board, and a backboard, etc. Among them, the backboard can be configured as a substrate to provide support; light beads can be installed on the light board, which are configured to provide backlight; the bracket can be configured to support the diffusion plate, the film, etc., to maintain an optical distance between the light board and the diffusion plate; the reflector can be configured to reflect the backlight from the light board in the direction of the diffusion plate; the backlight emitted from the light board can be provided to the display panel through a structure such as the diffusion plate, where the structure, such as the diffusion plate, can be configured to uniformize the brightness and angle of the light, so that the entire display panel is more uniform in the brightness distribution.

In some embodiments, the backlight module 11 can include a plurality of light boards, each light board can include a plurality of light-emitting areas, each light-emitting area (also known as a partition) can include a plurality of micrometer level light beads distributed in an array and corresponding one or more drive chips, each light bead may be an LED (Light Emitting Diode) light. On the light board, at least one light bead placed in a preset order can be in a serial connection to form a light string. The drive chip can be connected with the at least one corresponding light string. An arrangement order of the light beads on the light string may be a horizontal arrangement or a vertical arrangement, or an arrangement based on a preset pattern.

A drive chip of each partition can receive the same quantity of the processed drive data sent by the Bcon, so that respective channels of the drive chip can drive, based on the corresponding drive data, a light string connected to the drive chip to emit light, achieving local backlight control of the backlight module 11, i.e. achieving Local dimming, thereby achieving more accurate area lighting control and making the screen brightness more uniform and harmonious. Among them, the light board 30 may be composed of micro LEDs, including mini LEDs and OLEDs.

In related arts, each row of light beads in the light board can include a plurality of light strings (partitions), and the drive chips can include a same channel quantity, where each light string may correspond to one channel, and at least one controller can send the same quantity of drive data to a respective drive chip to enable a respective channel to obtain corresponding drive data. However, in some cases, a quantity of light strings in each row of light beads cannot exactly match the channel quantity of the drive chip, resulting in idle channels in the drive chip. For example, each row of light beads has a total of 14 partitions and uses 6-channel drive chips. If 2 drive chips are used, it is insufficient, so only 3 drive chips can be used, leaving 4 surplus channels. This reduces the utilization rate of the drive chip, thereby increasing the cost and occupied area of a drive circuit.

A drive group can use drive chips with a conformable specification, for example, all for 6 or 4 channels, which can easily lead to the problem of idle channels mentioned above. If the drive chips with different channel quantities are in hybrid connection, the occurrence of the above problem can be avoided. For example, in the aforementioned scenario where each row of light beads consists of 14 partitions, two 4-channel drive chips and one 6-channel drive chip can be used for hybrid connection, which perfectly matches the quantity of partitions in each row. Therefore, the hybrid connection of drive chips with different channel quantities can avoid idle channels in the drive chips, thereby improving the utilization rate of the drive chips. However, the difficulty of implementing the hybrid connection lies in the fact that the channel quantities of the respective drive chips are not same or fixed after the hybrid connection, and communication between the at least one controller and the respective drive chips will become chaotic, which makes it impossible for the drive chip to obtain the corresponding drive data, resulting in that the drive chip cannot work properly.

In the below, specific embodiments are used to explain the content of the present application in detail. The following specific embodiments can be combined with each other, and same or similar concepts or processes may not be repeated in some embodiments. In the description of the present application, unless otherwise specified and limited, each term shall be broadly understood within the field. In the below, the embodiments of the present application are described in conjunction with the drawings.

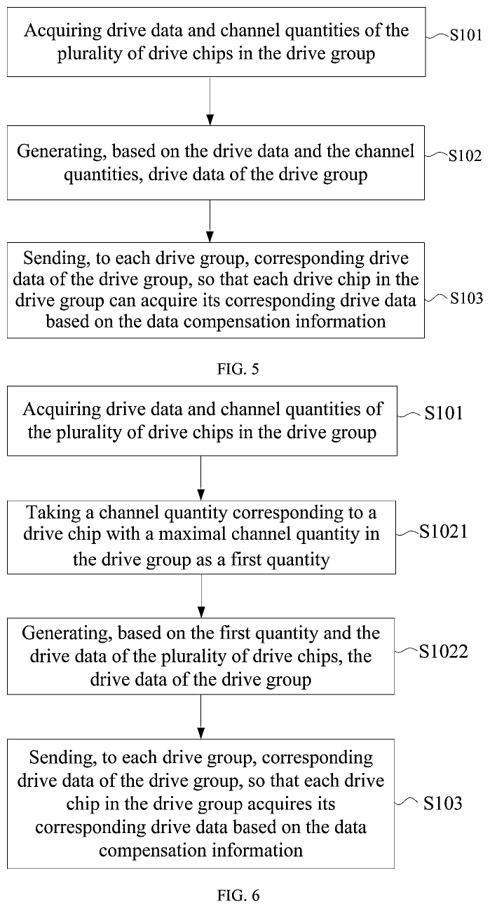

FIG. 5 is a schematic flowchart of a data communication method according to another embodiment of the present application. The method can be executed by an electronic device (i.e. the method is for the electronic device), where the electronic device may include at least one controller, the at least one controller can be connected to a drive group, the drive group can include a plurality of drive chips sequentially connected in series, and at least one drive chip of the plurality of drive chips has a different channel quantity from remainder drive chips; as shown in FIG. 5, the method can include the following.

S101: for each drive group, acquiring drive data and channel quantities of the plurality of drive chips in the drive group.

S102: generating, based on the drive data and the channel quantities, drive data of the drive group.

The drive data of the drive group can include a plurality of data segments corresponding one-to-one with the drive chips, and the drive data of the drive group can include data compensation information related to the channel quantities of the respective drive chips.

S103: sending, to each drive group, corresponding drive data of the drive group, so that each drive chip in the drive group can acquire its corresponding drive data based on the data compensation information.

In some embodiments, a drive circuit can include a plurality of drive groups, each drive group can correspond to a row of light beads in a light board. Due to the fact that a display apparatus usually performs displaying based on a line scanning technology, the drive data in the drive chips of each drive group can be sent by a data line, which can prevent the drive data in the drive chips of the same drive group from being received at significantly varied times.

Since the drive data can include the data compensation information related to the channel quantities of the drive chips, when the drive data of the drive group is obtained, the drive chip can acquire drive data corresponding to its respective channels from the drive data based on data compensation data, which neither results in idle channels in the drive chips, nor causes data reading errors in the drive chips.

In the below, a plurality of specific embodiments will be combined to explain the data communication method in the present application.

FIG. 6 is a schematic flowchart of a data communication method according to another embodiment of the present application, as shown in FIG. 6, S102 can include the following.

S1021: taking a channel quantity corresponding to a drive chip with a maximal channel quantity in the drive group as a first quantity.

S1022: generating, based on the first quantity and the drive data of the plurality of drive chips, the drive data of the drive group.

Then the at least one controller can send the drive data to the drive group based on the above drive data, so that each drive chip in the drive group can acquire a corresponding data segment from the drive data of the drive group, and determine, based on the channel quantity of the drive chip, the drive data of the drive chip from the acquired data segment.

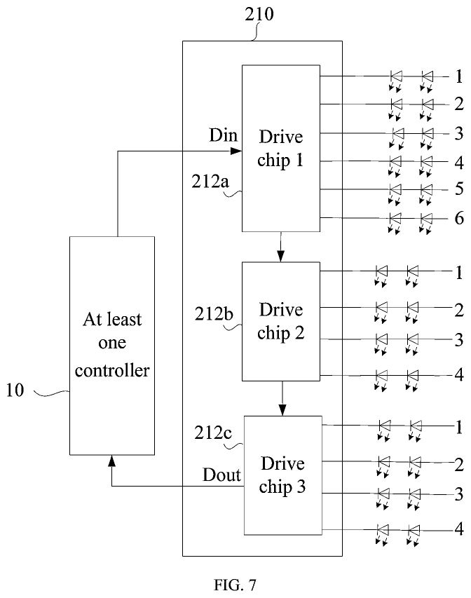

In some embodiments, the drive group can include at least one drive chip that has a different channel quantity from remainder drive chips, it also indicates that drive chips in hybrid connection exist in the drive group, and the plurality of drive chips can be connected in series. FIG. 7 is a schematic structure diagram of a display apparatus according to some other embodiments. As shown in FIG. 7, a drive group 210 connected with at least one controller 10 can include a first drive chip 212a, a second drive chip 212b, and a third drive chip 212c, where both the second drive chip 212b and the third drive chip 212c use 4 channels, the first drive chip 212a uses 6 channels. The channel quantities of the drive chips are exactly equal to the quantity of partitions of each row of light beads. Therefore, based on the present solution, idle channels will not be caused in the drive chips.

On this basis, in S101, the drive data of the drive chip can be acquired, where the drive chip needs to control a light string connected thereto based on the drive data. The first quantity is a channel quantity corresponding to the drive chip with a maximal channel quantity, as shown in FIG. 7, the channel quantity of the first drive chip 212a, i.e., 6, is the first quantity.

Regarding S1022, the drive data of the drive group can include a plurality of data segments corresponding one-to-one with the plurality of drive chips, and each data segment can include the first quantity of data. For example, with continued reference to FIG. 7, if the drive group can include 3 drive chips, then the drive data of the drive group can include 3 data segments, and each data segment can include 6 pieces of data. It should be noted that each data can be understood as data for controlling one channel, that is to say, each data segment can include data for 6 channels.

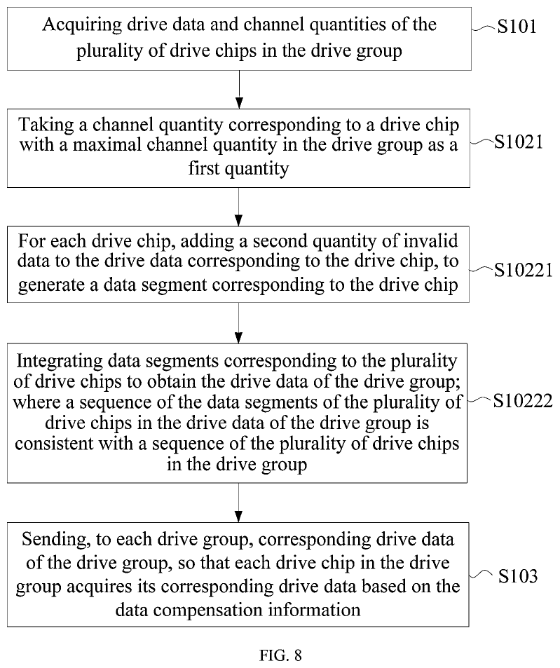

According to some embodiments, FIG. 8 is a schematic flowchart of another data communication method in another embodiment of the present application. As shown in FIG. 8, S1022 can include the following.

S10221: for each drive chip, adding a second quantity of invalid data to the drive data corresponding to the drive chip, to generate a data segment corresponding to the drive chip.

The data compensation information can include second quantities of invalid data corresponding to the respective drive chips.

S10222: integrating data segments corresponding to the plurality of drive chips to obtain the drive data of the drive group; where a sequence of the data segments of the plurality of drive chips in the drive data of the drive group is consistent with a sequence of the plurality of drive chips in the drive group.

In some embodiments, a solution for generating drive data of a drive group is discussed for illustration, where the second quantities are differences between the first quantity and the channel quantities of the drive chips. In other words, in this embodiment, for the drive data of the drive chip, the second quantity of invalid data can be added to the dive data, so that the data segment can include the first quantity of data.

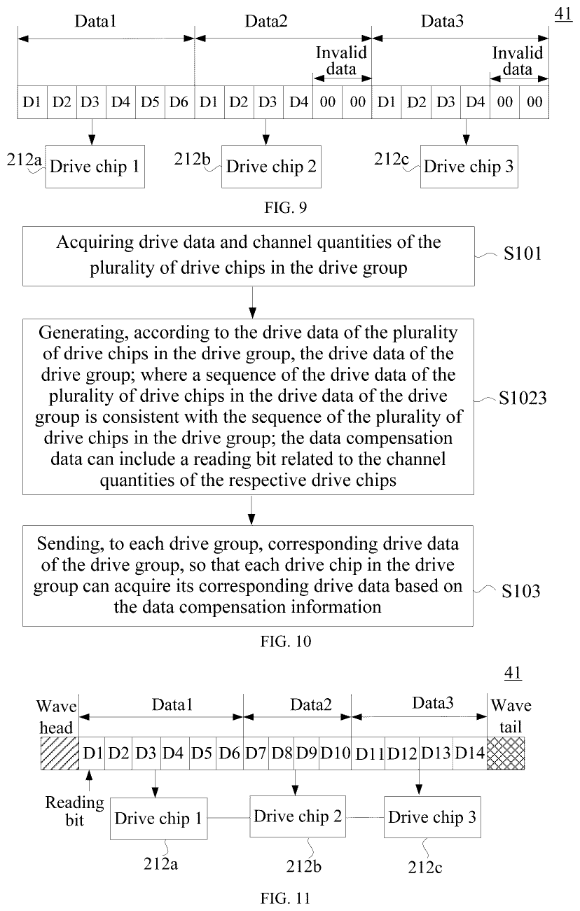

In the below, embodiments will be provided in conjunction with actual scenarios: FIG. 9 is a schematic structure diagram of drive data of a drive group according to some embodiments. As shown in FIG. 9, the drive group can include the first drive chip 212a, the second drive chip 212b and the third drive chip 212c, which correspond to a first data segment data1, a second data segment data2 and a third data segment data3 in the drive data of the drive group. Referring to FIG. 7, it can be seen that the first drive chip 212a has 6 channels, and corresponds to 6 pieces of drive data; the second drive chip 212b and the third drive chip 212c both have 4 channels, and correspond both to 4 pieces of drive data, where the first quantity is 6; for the first drive chip 212a, the second quantity is 0, so no invalid data can be added to the corresponding drive data (D1-D6); for the second drive chip 212b and the third drive chip 212c, the second quantity is 2, so two pieces of invalid data 00 can be added after the corresponding drive data. Therefore, the first data segment data1, the second data segment data2, and the third data segment data3, all of which contains 6 pieces of data can be generated. These three data segments can be combined to generate drive data 41 of the drive group.

In some embodiments, in a data segment corresponding to a drive chip, invalid data may be located after the drive data of the drive chip. In this way, when the drive chip acquires corresponding data, it can directly read in sequence the forepart valid drive data, thereby saving time in acquiring valid drive data. In another embodiment, the invalid data can also be placed before the drive data of the drive chip.

In this embodiment, the second quantity of invalid data can be added to the drive data of the drive chip, so that the data segment corresponding to the drive chip can maintain the first quantity of data. In this way, for the drive chips, each data segment has the same quantity of data therein, and corresponding data segments can be directly acquired in sequence, therefore an orderly transmission of data can be ensured, so that the drive chips with different channel quantities can acquire corresponding drive data.

After generating the drive data for the drive group as mentioned above, the drive data of the drive group can be sent to the drive group. The respective drive chip in the drive group can acquire a corresponding data segment in sequence, and then sequentially read data corresponding to the channel quantity from the data segment as the drive data of the drive chip. Based on the drive data, the connected light string can be controlled.

With further reference to FIG. 9, after the at least one controller sends the drive data of the drive group, the first drive chip 212a can acquire the first quantity (6 pieces) of data starting from a first position, the second drive chip 212b can acquire 6 pieces of data in sequence starting from a 7-th position, and the third drive chip 212c can acquire 6 pieces of data starting from a 13-th position, thereby achieving the acquisition of the corresponding data segments and further the acquisition of the drive data from the data segments. If a data segment is generated according to the channel quantity of the corresponding drive chip instead of the first quantity, a problem of chaotic data may occur. For example, if the first data segment contains 6 pieces of data, and both the second data segment and the third data segment contain 4 pieces of data, after the first drive chip acquires 6 pieces of data from a starting position: for the second drive chip and the third drive chip, they do not know how much data a previous drive chip has acquired, and they do not know from which position to start acquiring data, which leads to the drive chip being unable to acquire corresponding drive data. In some embodiments, a quantity for acquisition by each drive chip can be the first quantity, so each drive chip can acquire the corresponding data segment from a corresponding position.

In some embodiments, the drive data of the drive group can be generated based on the first quantity and the drive data of the plurality of drive chips, where the drive data of the drive group can include a plurality of data segments corresponding one-to-one with the plurality of drive chips, and each data segment can include the first quantity of data. In this way, for the drive chips, each data segment can have the same quantity of data therein, the drive chip can directly acquire a corresponding data segment in sequence without considering the difference between channel quantities of the drive chips. Therefore, based on this solution, it can be ensured that the drive chips with different channel quantities can acquire corresponding drive data in order, thereby achieving the hybrid connection of the drive chips with different channel quantities, thereby improving the utilization rate of the drive chips to reduce the cost and occupied area of a drive circuit.

FIG. 10 is a schematic flowchart of a data communication method according to another embodiment of the present application. As shown in FIG. 10, S102 can include the following.

S1023: generating, according to the drive data of the plurality of drive chips in the drive group, the drive data of the drive group; where a sequence of the drive data of the plurality of drive chips in the drive data of the drive group is consistent with the sequence of the plurality of drive chips in the drive group; the data compensation information can include a reading bit related to the channel quantities of the respective drive chips.

In some embodiments, the drive group can include at least one drive chip that has a different channel quantity from remainder drive chips, it also indicates that drive chips in hybrid connection exist in the drive group, and the plurality of drive chips can be connected in series. The data communication method according to this embodiment can be also applicable to the display apparatus shown in FIG. 7. The structure of the display apparatus has been described in previous embodiments and will omit here.

On this basis, firstly the drive data of the respective drive chips of the drive group can be acquired, where the quantities of drive data of the drive chips are consistent with the channel quantities of the drive chips. Then, the drive data of the respective drive chips can be arranged in the order of the respective drive chips in the drive group to generate drive data of the drive group, and the reading bit can be set in the drive data. As an example, the drive data of the drive group can include a wave head, the reading bit may be located at a bit succeeding the wave head. In this way, the drive chip is enabled to quickly read the corresponding drive data.

For example, FIG. 11 is a schematic structure diagram of drive data of a drive group according to some embodiments. As shown in FIG. 7 and FIG. 11, the drive group can include the first drive chip 212a, the second drive chip 212b and the third drive chip 212c which can be connected in series, and which correspond to channel quantities 6, 4, and 4 in sequence and correspond to drive data Data1, Data2, and Data3 in sequence. Therefore, the drive data 41 of the drive group including 14 pieces of data can be generated, the drive data 41 of the drive group may further include a wave head and a wave tail, and the bit succeeding the wave head can be set as a reading bit (at D1 in the figure).

After generating the drive data of the drive group as mentioned above, the drive data of the drive group can be sent to the drive group, each drive chip in the drive group can acquire data in the channel quantity of the drive chip starting from the reading bit, as the drive data of the drive chip; and drive data corresponding to a next drive chip of the drive chip can be shifted to the reading bit, to enable the next drive chip to also read corresponding drive data from the reading bit.

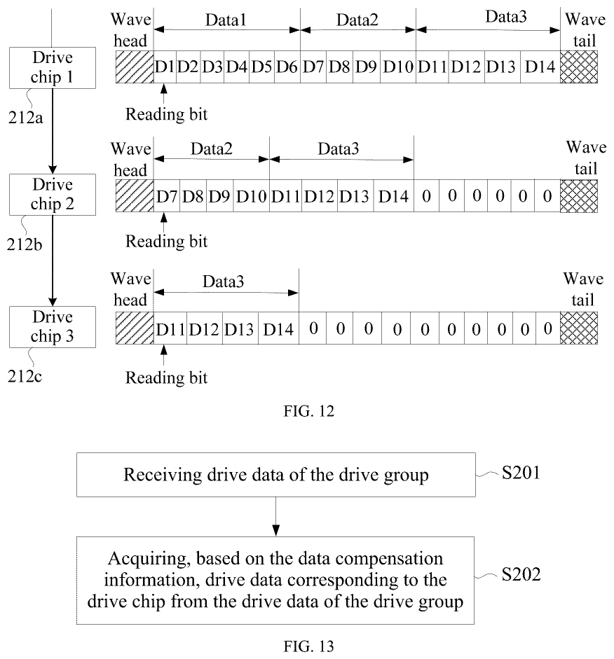

For example, FIG. 12 is a schematic flowchart of a drive chip reading drive data according to some embodiments. As shown in FIG. 12, the drive data of the drive group can include the drive data Data1, the drive data Data2, and the drive data Data3 of the 3 drive chips; the first drive chip 212a can read 6 pieces of data starting from the reading bit, i.e. Data1, then shift the remaining Data2 to the reading bit; then the second drive chip 212b can read 4 pieces of data starting from the reading bit, i.e. Data2, the second drive chip 212b can shift the Data3 to the reading bit; the third drive chip 212c can read 4 pieces of data starting from the reading bit, i.e. Data3, to complete the reading of the drive data by the three drive chips.

In some embodiments, according to the drive data of the plurality of drive chips in the drive group, the drive data of the drive group can be generated, where a sequence of the drive data of the plurality of drive chips in the drive data of the drive group is consistent with a sequence of the plurality of drive chips in the drive group, and a reading bit can be set in the drive data of the drive group. After the drive data is sent to the drive group, a drive chip in the drive group can read data corresponding to a channel quantity starting from the reading bit as the drive data of the drive chip, and shift drive data corresponding to a next drive chip to the starting position, so that each drive chip can read the corresponding drive data starting from the reading bit, without the problem of chaotic data reading caused by different channel quantities in the respective drive chips being occurred. Therefore, based on this solution, it can be ensured that drive chips with different channel quantities can acquire corresponding drive data in order, thereby achieving hybrid connection for drive chips with different channel quantities, thereby improving the utilization rate of the drive chips to reduce the cost and occupied area of a drive circuit.

FIG. 13 is a schematic flowchart of a data communication method according to another embodiment of the present application. The method can be applied in a drive chip, where the drive chip can be included in a drive group, the drive group can include a plurality of drive chips sequentially connected in series, and at least one drive chip of the plurality of drive chips has a different channel quantity from remainder drive chips, the drive group can be connected with at least one controller; as shown in FIG. 13, the method can include the following.

S201, receiving drive data of the drive group.

The drive data of the drive group can be generated by the at least one controller based on drive data and channel quantities of the plurality of drive chips, the drive data of the drive group can include a plurality of data segments corresponding one-to-one with the drive chips, and the drive data of the drive group can include data compensation information related to the channel quantities of the respective drive chips.

S202, acquiring, based on the data compensation information, drive data corresponding to the drive chip from the drive data of the drive group.

In the above embodiments, at least one processor can transmit the drive data of the drive group to the corresponding drive group. Since the drive data of the drive group can include data compensation information related to the channel quantities of the respective drive chips of the drive group, the respective drive chips can accurately read data based on the data compensation information to ensure the normal display of respective light strings in the display apparatus shown in FIG. 7.

In the below, a plurality of specific embodiments will be combined to explain the data communication method in the present application.

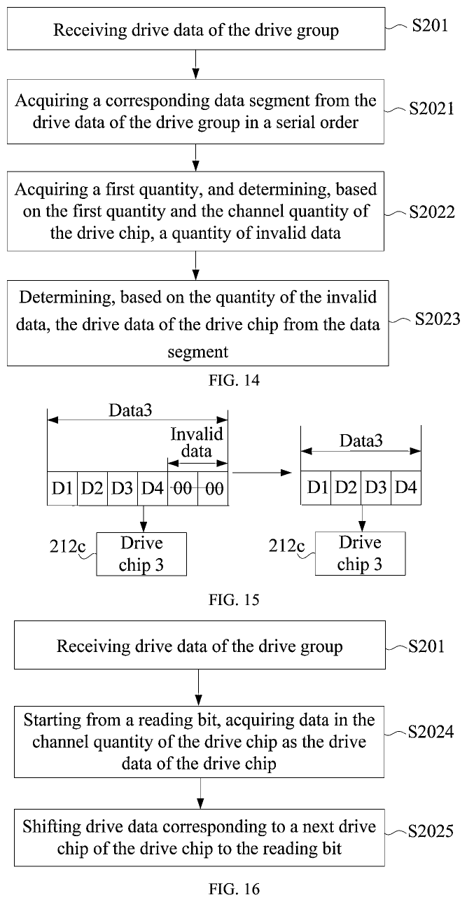

FIG. 14 is a schematic flowchart of a data communication method according to another embodiment of the present application. As shown in FIG. 14, S202 can include the following.

S2021, acquiring a corresponding data segment from the drive data of the drive group in a serial order.

S2022, acquiring a first quantity, and determining, based on the first quantity and the channel quantity of the drive chip, a quantity of invalid data.

S2023, determining, based on the quantity of the invalid data, the drive data of the drive chip from the data segment.

Data compensation information can include invalid data generated based on the channel quantities of the drive chips.

In some embodiments, the drive chip may be taken as the execution body. In S201, the drive data of the drive group can be received, where the drive data of the drive group can be generated by the at least one controller based on the first quantity and the drive data of the plurality of drive chips, the first quantity is a channel quantity corresponding to the drive chip with a maximal channel quantity in the drive group; the drive data of the drive group can include a plurality of data segments corresponding one-to-one with the drive chips, and each data segment can include the first quantity of data. Then the corresponding data segment can be acquired from the drive group in order.

For example, as shown in FIG. 9, the drive group can include the first drive chip 212a, the second drive chip 212b and the third drive chip 212c, the first quantity is 6, the received drive data of the drive group can include 18 pieces of data, a bit succeeding a wave head is taken as a starting position, the first drive chip 212a can acquire 6 pieces of drive data starting from the starting position, the 6 pieces of data serve as a data segment corresponding to the first drive chip 212a, the second drive chip 212b can acquire 6 pieces of data starting from the 7-th bit as a data segment corresponding to the second drive chip 212b, and the third drive chip 212c can acquire 6 pieces of data starting from the 13-th bit as a data segment corresponding to the third drive chip 212c. That is to say, an n-th drive chip can acquire m pieces of data from [m(n−1)+1]-th bit as its data segment, where m is the first quantity.

After acquiring the corresponding data segment as described above, S2022 can be executed, where the first quantity can be acquired, and the drive data of the drive chip can be determined from the data segment based on the first quantity and the channel quantity of the drive chip.

As an example, the drive data of the drive group can be formed by integrating, by the at least one controller, the data segments corresponding to the plurality of drive chips, a sequence of the data segments of the plurality of drive chips in the drive data of the drive group is consistent with a sequence of the plurality of drive chips in the drive group, where a data segment corresponding to a drive chip can be generated by adding a second quantity of invalid data to the drive data corresponding to the drive chip, the second quantity is a difference between the first quantity and the channel quantity of the drive chip; subtracting the channel quantity of the drive chip from the first quantity to obtain the second quantity for the invalid data (S2022); deleting the second quantity of the invalid data from the data segment to generate the drive data of the drive chip (S2023).

In this embodiment, the data segment of the drive chip can be acquired by adding the second quantity of the invalid data to the drive data of the drive chip, therefore, after acquiring the data segment of the drive chip, the second quantity of the invalid data can be removed from the data segment, what remains is the drive data of the drive chip. For example, FIG. 15 is a schematic structure diagram of a data segment according to some embodiments. As shown in FIG. 15, and in conjunction with FIG. 9, after the third drive chip 212c acquires corresponding data segment Data3, the second quantity is 6−4=2, then 2 pieces of invalid data 00 can be deleted from Data3, therefore the drive data D1, D2, D3, and D4 of the drive chip can be acquired.

It should be noted that when deleting the second quantity of invalid data, the invalid data can be deleted from a predetermined position in an agreed manner. As an implementation, in the data segment corresponding to the drive chip, the invalid data may be located after the drive data of the drive chip. In this scenario, the second quantity of data can be deleted starting from the end of the first quantity of data forwardly in an agreed manner, to generate data for the drive chip. In this way, when the drive chip acquires the corresponding data segment, it can directly read in sequence the forepart valid drive data, thereby saving time in acquiring the valid drive data. Of course, the invalid data can also be placed before the drive group of the drive chip.

In some embodiments, the drive data generated by the at least one controller based on the first quantity and the drive data of the plurality of drive chips can be received, the plurality of data segments correspond one-to-one with the drive chips, and each data segment can include the first quantity of data. Therefore, a corresponding data segment can be acquired from the drive data of the drive group in a serial order, the drive data of the drive chip can be determined from the data segment based on the first quantity and the channel quantity of the drive chip without considering the difference between the channel quantities of the drive chips. Therefore, based on this solution, it can be ensured that the drive chips with different channel quantities can acquire corresponding drive data in order, thereby achieving the hybrid connection for the drive chips with different channel quantities, thereby improving the utilization rate of the drive chips to reduce the cost and occupied area of a drive circuit.

FIG. 16 is a schematic flowchart of a data communication method according to another embodiment of the present application. As shown in FIG. 16, S202 can include the following.

S2024, starting from a reading bit, acquiring data in the channel quantity of the drive chip as the drive data of the drive chip.

S2025, shifting drive data corresponding to a next drive chip of the drive chip to the reading bit.

In S201, the received drive data of the drive group can be generated by the at least one controller based on the drive data of the plurality of drive chips in the drive group; a sequence of the drive data of the plurality of drive chips in the drive data of the drive group is consistent with a sequence of the plurality of drive chips in the drive group; the drive data of the drive group can include data compensation data, the data compensation information can include a reading bit, the structure of the drive data of the drive group can be shown in FIG. 11.

In S2024, starting from the reading bit, data in the channel quantity of the drive chip can be acquired as the drive data of the drive chip, where the reading bit may be located at any bit in the drive data of the drive group, a function of the reading bit is to specify a reading position of a respective drive chip. As an example, the drive data of the drive group can include a wave head, the reading bit may be located at a bit succeeding the wave head. In this way, the drive chip can quickly read corresponding drive data; in addition, the reading bit is continuous with the wave head, no additional storage location is occupied, thus improving storage efficiency.

In S2025, after the drive chip completes the reading, it is also necessary to shift drive data corresponding to a next drive chip of the drive chip to the reading bit, so that each drive chip can acquire corresponding drive data from the reading bit.

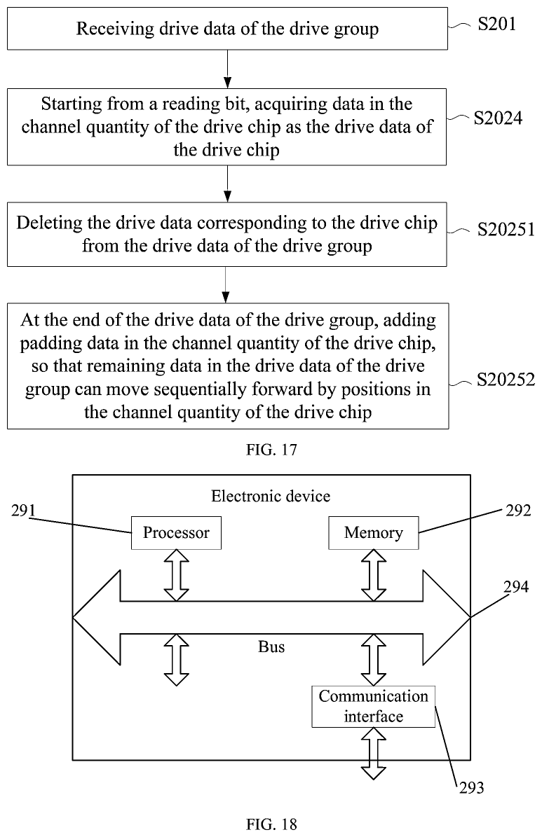

According to some other embodiments, FIG. 17 is a schematic flowchart of another data communication method according to another embodiment of the present application. As shown in FIG. 17, S2025 can include the following.

S20251: deleting the drive data corresponding to the drive chip from the drive data of the drive group.

S20252: adding padding data in the channel quantity of the drive chip at the end of the drive data of the drive group, so that remaining data in the drive data of the drive group can move sequentially forward by positions in the channel quantity of the drive chip.

In the below, exemplary description will be provided in combination with a specific scenario: as shown in FIG. 12, the drive group can include the first drive chip 212a, the second drive chip 212b and the third drive chip 212c, which correspond to channel quantities 6, 4, and 4 in sequence and correspond to drive data Data1, Data2, and Data3 in sequence; the drive data received by the drive group can include Data1, Data2, and Data3, where Data1 can include 6 pieces of data, Data2 and Data3 include 4 pieces of data respectively, the reading bit is located at a bit succeeding the wave head. After receiving the drive data of the drive group, each drive chip can know its own channel quantity, therefore, starting from the reading bit, the first drive chip 212a can acquire 6 pieces of data, i.e. D1-D6, and takes D1-D6 as the drive data of this drive chip. Then, Data1, i.e. D1-D6, is deleted, 6 pieces of padding data 0 can be added at the end of Data3. In this way, Data2 and Data3 move forward by 6 positions in sequence, so that D7 in Data2 is located at the reading bit, then the second drive chip 212b can read Data2 starting from D7; then Data2 is deleted, and 4 pieces of padding data 0 can be added at the end of Data3, so that data D11-D14 in Data3 can move forward by 4 positions and D11 can move to the reading bit; the third drive chip 212c can read Data3 starting from the reading bit, thereby completing the acquisition of corresponding drive data by respective drive chips.

In this embodiment, the drive data of the drive chip can be deleted and the padding data in the channel quantity of the drive chip can be added at the end of the drive data of the drive group. This manner achieves that drive data corresponding a next drive chip of the drive chip can be shifted to the reading bit, so that the next drive chip can read corresponding drive data from the reading bit, thereby ensuring that the drive chips with different channel quantities can acquire corresponding drive data in order.

In some embodiments, the drive data of the drive group generated by the at least one controller based on the drive data of the plurality of drive chips in the drive group can be received; the drive data of the drive group can include a reading bit, data in a channel quantity of a drive chip can be read starting from the reading bit as the drive data; then the read drive data can be deleted and drive data corresponding to a next drive chip can be shifted to the reading bit, so that each drive chip can read corresponding drive data starting from the reading bit, without the problem of chaotic data reading caused by different channel quantities in the respective drive chips being occurred. Therefore, in some embodiments, it can be ensured that drive chips with different channel quantities can acquire corresponding drive data in order, thereby achieving a hybrid connection for drive chips with different channel quantities.

FIG. 18 is a schematic structure diagram of an electronic device according to some embodiments of the present application. As shown in FIG. 8, the electronic device can include a processor 291, where the electronic device further can include a memory 292; the electronic device further can include a communication interface 293 and a bus 294. The processor 291, the memory 292, and the communication interface 293 can have communication with each other through the bus 294. The communication interface 293 can be used for information transmission. The processor 291 can call logical instructions in the memory 292 to execute the methods described in the above embodiments.

In addition, the logical instructions in the above memory 292 may be implemented in a form of software function unit, and stored in a computer readable storage medium when being sold or used as an independent product.

The memory 292, as a computer readable storage medium, can be used to store a software program, a computer executable program, and program instructions/modules corresponding to the methods in the embodiments of the present application. The processor 291 can execute functional applications and data processing by running the software programs, instructions, and modules stored in the memory 292, thereby implementing the methods in the above method embodiments.

The memory 292 may include a program storage area and a data storage area, where the program storage area may store an application program required by an operating system or at least one function; the data storage area can store data created according to the use of terminal devices, etc. In addition, the memory 292 may include a high speed random access memory, and may also include a non-volatile memory.

The embodiments of the present application further provide a computer readable storage medium, where the computer readable storage medium can store computer executable instructions thereon, where when the computer executable instructions are executed by a processor, the processor can be used to implement the method of any embodiment.

Those skilled in the art will easily come up with other embodiments of the present application after considering the specification and practicing the present application disclosed herein. The present application aims to cover any variations, uses, or adaptive changes of the present application, these variations, uses, or adaptive changes follow the general principles of the present application and include common knowledge or customary technical means in the technical field not disclosed in the present application. The specification and embodiments are only considered exemplary, and the true scope and spirit of the present application are indicated by the claims.

It should be understood that the present application is not limited to the precise structure described above and shown in the drawings, and various modifications and changes can be made without departing from its scope. The scope of the present application is limited only by the accompanying claims.

What is claimed is:

1. A data communication method for an electronic device, wherein the electronic device comprises at least one controller, the at least one controller is connected to at least one drive group, the drive group comprises a plurality of drive chips sequentially connected in series, and at least one drive chip of the plurality of drive chips has a different channel quantity from remainder drive chips; the method comprises:
for each drive group, acquiring drive data and channel quantities of the plurality of drive chips in the drive group;
generating, based on the drive data and the channel quantities, drive data of the drive group; wherein the drive data of the drive group comprises a plurality of data segments corresponding one-to-one with the drive chips, and the drive data of the drive group comprises data compensation information related to the channel quantities of the respective drive chips; and
sending, to each drive group, corresponding drive data of the drive group, so that each drive chip in the drive group acquires its corresponding drive data based on the data compensation information.

2. The method according to claim 1, wherein the generating, based on the drive data and the channel quantities, the drive data of the drive group comprises:
acquiring a channel quantity corresponding to a drive chip with a maximal channel quantity in the drive group as a first quantity; and
generating, based on the first quantity and the drive data of the plurality of drive chips, the drive data of the drive group; wherein the drive data of the drive group comprises a plurality of data segments corresponding one-to-one with the plurality of drive chips, and each data segment comprises the first quantity of data.

3. The method according to claim 2, wherein the data compensation information comprises second quantities of invalid data corresponding to the respective drive chips; for the respective drive chips, the second quantities are differences between the first quantity and the channel quantities of the drive chips;
wherein the generating, based on the first quantity and the drive data of the plurality of drive chips, the drive data of the drive group comprises:
for each drive chip, adding a second quantity of invalid data to drive data corresponding to the drive chip, to generate a data segment corresponding to the drive chip; and
integrating data segments corresponding to the plurality of drive chips to obtain the drive data of the drive group; wherein a sequence of the data segments of the plurality of drive chips in the drive data of the drive group is consistent with a sequence of the plurality of drive chips in the drive group.

4. The method according to claim 3, wherein the invalid data, in the data segment corresponding to the drive chip, is located after the drive data of the drive chip.

5. The method according to claim 1, wherein the generating, based on the drive data and the channel quantities, the drive data of the drive group comprises:
generating, according to the drive data of the plurality of drive chips in the drive group, the drive data of the drive group; wherein a sequence of the drive data of the plurality of drive chips in the drive data of the drive group is consistent with a sequence of the plurality of drive chips in the drive group; the data compensation information comprises a reading bit related to the channel quantities of the respective drive chips.

6. The method according to claim 5, wherein the drive data of the drive group comprises a wave head, the reading bit is located at a bit succeeding the wave head.

7. A data communication method for a drive chip, wherein the drive chip is comprised in a drive group, the drive group comprises a plurality of drive chips sequentially connected in series, and at least one drive chip of the plurality of drive chips has a different channel quantity from remainder drive chips, the drive group is connected with at least one controller; the method comprises:
receiving drive data of the drive group; wherein the drive data of the drive group is generated by the at least one controller based on drive data and channel quantities of the plurality of drive chips, the drive data of the drive group comprises a plurality of data segments corresponding one-to-one with the drive chips, and the drive data of the drive group comprises data compensation information related to the channel quantities of the respective drive chips; and
acquiring, based on the data compensation information, drive data corresponding to the drive chip from the drive data of the drive group.

8. The method according to claim 7, wherein the drive data of the drive group is generated by the at least one controller based on a first quantity and the drive data of the plurality of drive chips, the first quantity is a channel quantity corresponding to a drive chip with a maximal channel quantity in the drive group; the drive data of the drive group comprises a plurality of data segments corresponding one-to-one with the plurality of drive chips, each data segment comprises the first quantity of data; wherein the data compensation information comprises invalid data generated based on the channel quantities of the drive chips;
wherein the acquiring, based on the data compensation information, the drive data corresponding to the drive chip from the drive data of the drive group comprises:
acquiring a corresponding data segment from the drive data of the drive group in a serial order;
acquiring the first quantity, and determining, based on the first quantity and the channel quantity of the drive chip, a quantity of invalid data; and
determining, based on the quantity of the invalid data, the drive data of the drive chip from the data segment.

9. The method according to claim 8, wherein the drive data of the drive group is formed by integrating, by the at least one controller, the data segments corresponding to the plurality of drive chips; wherein the data segment corresponding to the drive chip is generated by adding a second quantity of invalid data to the drive data corresponding to the drive chip, the second quantity is a difference between the first quantity and the channel quantity of the drive chip, a sequence of the data segments of the plurality of drive chips in the drive data of the drive group is consistent with a sequence of the plurality of drive chips in the drive group; the determining, based on the first quantity and the channel quantity of the drive chip, the quantity of the invalid data comprises:
subtracting the channel quantity of the drive chip from the first quantity to obtain the second quantity for the invalid data.

10. The method according to claim 9, wherein the determining, based on the quantity of the invalid data, the drive data of the drive chip from the data segment comprises:
deleting the second quantity of the invalid data from the data segment to generate the drive data of the drive chip.

11. The method according to claim 8, wherein the invalid data, in the data segment corresponding to the drive chip, is located after the drive data of the drive chip.

12. The method according to claim 7, wherein the drive data of the drive group is generated by the at least one controller based on the drive data of the plurality of drive chips in the drive group; a sequence of the drive data of the plurality of drive chips in the drive data of the drive group is consistent with a sequence of the plurality of drive chips in the drive group; the drive data of the drive group comprises data compensation data, the data compensation information comprises a reading bit;
wherein the acquiring, based on the data compensation information, the drive data corresponding to the drive chip from the drive data of the drive group comprises:
starting from the reading bit, acquiring data in the channel quantity of the drive chip as the drive data of the drive chip; and
shifting drive data corresponding to a next drive chip of the drive chip to the reading bit.

13. The method according to claim 12, wherein the shifting the drive data corresponding to the next drive chip of the drive chip to the reading bit comprises:
deleting the drive data corresponding to the drive chip from the drive data of the drive group; and
adding, at an end of the drive data of the drive group, padding data in the channel quantity of the drive chip, so that remaining data in the drive data of the drive group moves sequentially forward by positions in the channel quantity of the drive chip.

14. The method according to claim 12, wherein the drive data of the drive group comprises a wave head, the reading bit is located at a bit succeeding the wave head.

15. An electronic device, comprising: at least one processor, and a memory in connection with the at least one processor;
wherein the memory is configured to store computer executable instructions;
the at least one processor is configured to execute the computer executable instructions to cause the electronic device to perform:
for each drive group, acquiring drive data and channel quantities of the plurality of drive chips in the drive group;
generating, based on the drive data and the channel quantities, drive data of the drive group; wherein the drive data of the drive group comprises a plurality of data segments corresponding one-to-one with the drive chips, and the drive data of the drive group comprises data compensation information related to the channel quantities of the respective drive chips; and
sending, to each drive group, corresponding drive data of the drive group, so that each drive chip in the drive group acquires its corresponding drive data based on the data compensation information.
